(19) United States
(12) Patent Application Publication
(10) Pub. No.: US 2011/0174908 A1
(43) Pub. Date: Jul. 21, 2011

(54) SQUEEGEE WHISK

(75) Inventor: Heather Curtin, Duarte, CA (US)

(73) Assignee: PROGRESSIVE INTERNATIONAL CORPORATION, Kent, WA (US)

(21) Appl. No.: 13/011,542

(22) Filed: Jan. 21, 2011

Related U.S. Application Data
(60) Provisional application No. 61/297,218, filed on Jan. 21, 2010.

(51) Int. Cl. B02C 19/00

(52) U.S. Cl. 241/169.2

(57) ABSTRACT

A squeegee whisk includes a handle and an attached tool head in which the tool head is configured to be sufficiently rigid to mash food items such as cooked potatoes. The tool head is formed by a plurality of arms terminating in a mashing grid. The number of arms is designed to be sufficiently large to allow the tool head to serve as a whisk in addition to supporting the mashing grid. In some versions, the arms of the tool head include fins formed from a resilient material such that the fins are capable of scraping the sidewalls of a bowl and thereby serve as a squeegee or scraper.

### PRIORITY CLAIM

This application claims the benefit of prior U.S. provisional application Ser. No. 61/297,218, filed Jan. 21, 2010, the contents of which are hereby incorporated by reference.

### FIELD OF THE INVENTION

This invention relates generally to a kitchen tool, and more particularly to a kitchen tool that can be used both as a potato masher and a whisk.

### BACKGROUND OF THE INVENTION

Most potato mashers are constructed in a configuration that includes a handle that is connected to a mashing tool head. Typically, the tool head includes a flat mashing grid that is connected to the handle by a pair of supports that branch out from the handle and attach to the mashing grid on opposite sides. Though it works quite well for mashing solid foods such as potatoes, it is essentially a single-purpose tool. It can mash foods but is ineffective at stirring, blending, or whisking foods. In addition, a typical masher has no practical ability to scrape food items downward from along the sides of a bowl.

Whisks, on the other hand, tend to be formed using thin and somewhat flexible wires for the tool head. The wires form loops that readily collapse or spread apart if used in a mashing fashion, and whisks are generally not sturdy enough to be used to mash potatoes and the like. Thus, both tools are generally required for many tasks.

### SUMMARY OF THE INVENTION

A preferred version of the squeegee whisk includes a handle and an attached tool head in which the tool head is configured to be sufficiently rigid to mash food items such as cooked potatoes.

Most preferably, the tool head is formed by a plurality of arms terminating in a mashing grid. The number of arms is designed to be sufficiently large to allow the tool head to serve as a whisk in addition to supporting the mashing grid. Accordingly, the tool head doubles as a masher and a whisk.

In some versions of the invention, the arms of the tool head include fins formed from a resilient material such that the fins are capable of scraping the sidewalls of a bowl and thereby serve as a squeegee or scraper.

### BRIEF DESCRIPTION OF THE DRAWINGS

Preferred and alternative examples of the present invention are described in detail below with reference to the following drawings:

FIG. 1 is a perspective view of a preferred squeegee whisk.

FIG. 2 is a bottom view of the whisk of FIG. 1.

FIG. 3 is a front view of the whisk if FIG. 1.

### DETAILED DESCRIPTION OF THE PREFERRED EMBODIMENT

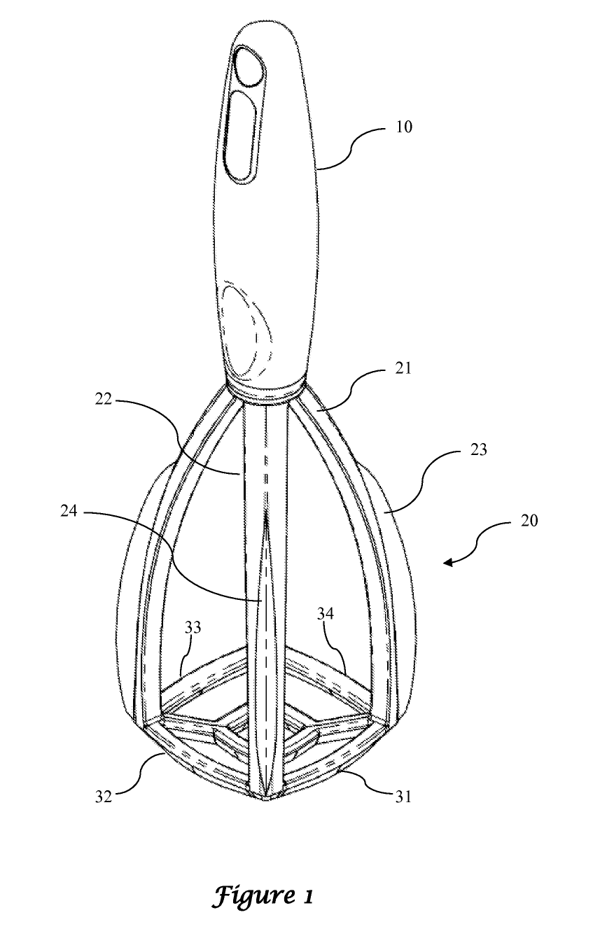

The preferred whisk in accordance with the present invention is described with reference to FIGS. 1-3. As shown, the whisk includes a handle 10 and a tool head 20. The tool head includes a plurality of arms (for example 21, 22) branching from the handle toward the mashing grid. As shown in the illustrated example, four arms are provided, though in alternate embodiments a greater or lesser number may be used. Because the tool head is intended to serve as a whisk in addition to a masher, most preferably three to five arms are provided.

Each of the arms is preferably formed with a high degree of structural rigidity sufficient to withstand forces such as would be experienced when mashing potatoes. Thus, in one example the arms are formed from metal such as stainless steel and are formed with a sufficient thickness such that the arms are highly rigid and substantially not bendable. Alternatively, the arms are formed from rigid plastic such as ABS or glass-reinforced polypropylene.

Each of the arms terminates at a connection to a mashing grid that is also formed from members that are highly rigid as with the arms themselves. The mashing grid is configured to provide a strong tool head that can be forced through potatoes and withstand the forces necessary to mash them. Thus, the mashing head includes a number of structural members connected to provide through-holes for the potatoes.

In the exemplary embodiment, the mashing grid includes a peripheral frame that is connected to each of the arms. As shown, the peripheral frame is comprised of four relatively straight frame members 31, 32, 33, 34. Though “relatively” straight as shown, they are slightly bowed outward. In alternate versions, the frame members may have a greater degree of curvature and may form more of a circle, octagon, or other shape rather than the bowed square shape as shown.

The peripheral frame includes a central hub 50 connected to the corners of the peripheral frame by a number of spokes radiating outwardly from the central hub. In the illustrated example, the central hub is shaped as a smaller version of the peripheral frame and therefore has a bowed square shape. Thus, the central hub includes four sides 41, 42, 43, 44 joined at four corners. Four spokes are provided, with one spoke joining a corner of the central hub to a corresponding corner of the peripheral frame. The central hub may optionally include one or more additional structural members, and in the illustrated embodiment it includes a pair of bisecting cross-members, one of the cross-members bisecting the central hub laterally and the other bisecting it vertically.

Other versions may include different arrangements of structural members to form the mashing grid, so long as the grid is preferably sufficiently rigid and sturdy for use in mashing potatoes and includes sufficient openings to allow potatoes or other such foods to pass through as they are mashed. In addition, the mashing grid may be formed as a unitary structure from a single material, or may be formed from a number of components joined together to form the unitary head.

As best seen in the side view of the tool, the preferred mashing grid is not flat, but rather is bowed outwardly in a direction extending axially away from the handle toward the tool head. In the illustrated version, the peripheral frame members define a plane that is generally orthogonal to a central axis defined by the handle. The portion of the mashing grid that is within the peripheral frame members are bowed outward beyond the plane of the peripheral frame, in a direction extending away from the handle. In the preferred version, the outward bow of the mashing grid follows an arc of curvature that continuously curves from one side of the peripheral frame to the other.

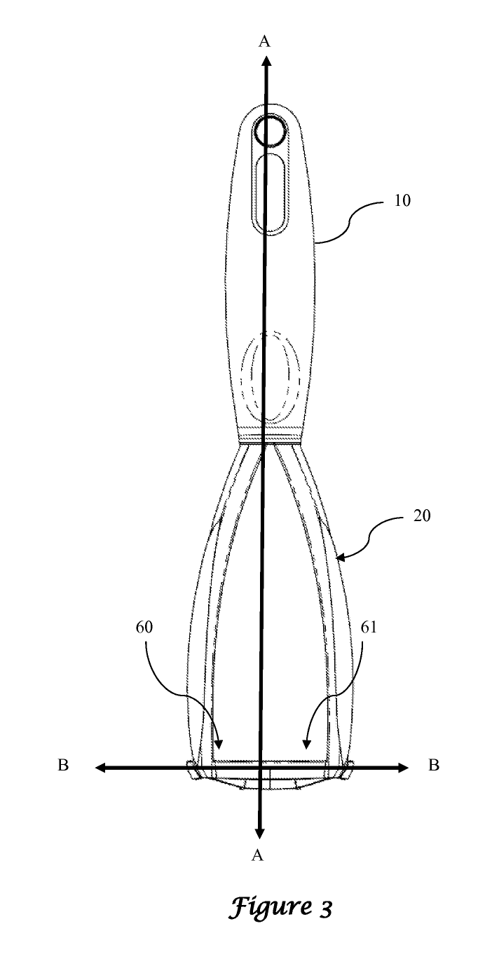

With reference to FIG. 3, the preferred shape of the mashing grid and arms is shown. The handle 10 extends along axis A-A, with the tool head extending away from the handle and along the same axis A-A. The frame members lie in plane B-B, orthogonal to the central axis A-A. Most preferably, as noted above, the central hub lies in a plane close to and parallel with the first plane B-B. The arms join to the frame members to form connection angles (for example, 60, 61) that are right angles in the illustrated version.

The arms of the tool head are curved outward as they extend toward the mashing grid. Together with the curvature of the mashing grid, the arms and mashing grid form a bulbous shape that resembles a tear drop. The generally rounded shape is intended to allow the tool to follow the corresponding curvature of a bowl when mashing or whisking. This overall shape of the tool allows it to be used when mashing potatoes in a bowl, rather than in a pot with a flat bottom. Traditional potato mashers have a flat base that makes them inefficient when used in a bowl with a round bottom. The exemplary versions of the current invention overcome this limitation by forming the mashing grid in a rounded shape.

The arms of the tool head further include fins (for example, 23, 24) extending radially outward from the arms. As shown, the fins begin substantially adjacent the peripheral frame of the mashing grid and extend along the arms and toward the handle for approximately ⅔ of the length of the arms. In other versions, the fins may extend along about half the length of the arms or may extend along the entire length of the arms. The fins include a base adjacent the arms and terminate in an edge that is radially outward from the base (with radially outward being defined as a direction radially outward from the central axis of the handle), such that the base is wider than the terminal edge. In the preferred version, the terminal edge forms a point that is sharp, meaning not sharp enough to cut but not blunt.

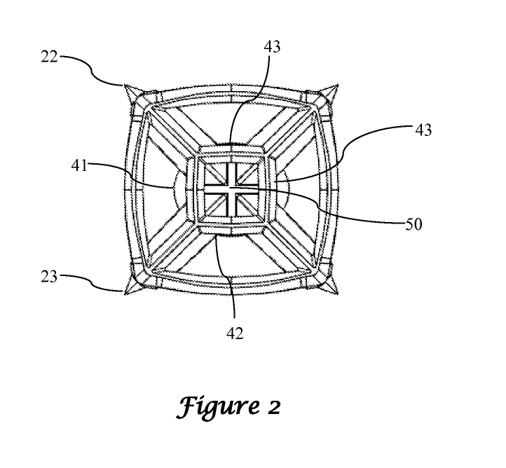

As best seen in the bottom view of FIG. 2, the fins extend along a radial direction that is substantially in line with the spokes. This preferred configuration allows the spokes to provide support and structural rigidity against forces applied to the fins.

The fins provided on the arms further allow the arms to be used as a squeegee or scraper along the sides of a bowl. Thus, the tool can be used for mashing and scraping as well. In some versions of the invention, the tool head (including the arms and the mashing grid) are formed with a plastic coating or other material that is resilient to improve the scraping ability.

In use, the whisk is constructed from materials and in a fashion that makes it sturdy enough to be used for mashing potatoes and the like. It can be used with bowls and is not restricted to pots with flat bottoms because of its rounded shape. During the mashing process the fins can be used for scraping the sides of the bowl and the inclusion of several arms and openings in the tool head allow the tool to be used as a traditional whisk rather than being limited to mashing potatoes.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A squeegee whisk, comprising:
a handle having a proximal end and a distal end defining a central axis; and
a tool head secured to the distal end of the handle, the tool head comprising:
a plurality of arms extending from the distal end of the handle, at least one of the plurality of arms having a fin extending radially outward in a direction away from the central axis, each of the plurality of arms terminating in a mashing grid.

2. The squeegee whisk of claim 1, wherein the plurality of arms comprises four arms.

3. The squeegee whisk of claim 2, wherein each one of the plurality of arms comprises a fin extending radially outward in a direction away from the central axis.

4. The squeegee whisk of claim 3, wherein each one of the fins is formed from a resilient material.

5. The squeegee whisk of claim 4, wherein each one of the plurality of arms is substantially rigid.

6. The squeegee whisk of claim 2, wherein the mashing grid comprises a peripheral frame connecting each one of the plurality of arms, a central hub surrounded by the peripheral frame, and a plurality of spokes connecting the central hub to the peripheral frame.

7. The squeegee whisk of claim 6 wherein the peripheral frame defines a first plane and the central hub defines a second plane, the first plane being parallel to the second plane.

8. The squeegee whisk of claim 7, wherein each of the plurality of fins is tapered as it extends radially outward.

9. The squeegee whisk of claim 8, wherein each of the plurality of fins comprises a terminal edge that is curved as it extends axially away from the handle.

10. A squeegee whisk, comprising:
a handle having a proximal end and a distal end defining a central axis; and
a tool head secured to the distal end of the handle, the tool head comprising:
at least three arms extending from the distal end of the handle, each one of the plurality of arms being substantially rigid;
at least three fins, wherein each one of the at least three fins is attached to a respective one of the at least three arms and configured to extend radially outward in a direction away from the central axis; and
a mashing grid secured to the at least three arms.

11. The squeegee whisk of claim 10, wherein each one of the fins is formed from a resilient material.

12. The squeegee whisk of claim 10, wherein the mashing grid comprises a peripheral frame connecting each one of the plurality of arms, a central hub surrounded by the peripheral frame, and a plurality of spokes connecting the central hub to the peripheral frame.

13. The squeegee whisk of claim 12 wherein the peripheral frame defines a first plane and the central hub defines a second plane, the first plane being parallel to the second plane.

14. The squeegee whisk of claim 10, wherein the mashing grid is secured to the at least three arms substantially orthogonally to each one of the arms.

15. The squeegee whisk of claim 10, wherein the at least three arms comprises four arms.

16. The squeegee whisk of claim 10, wherein each one of the at least three arms is permanently secured to the mashing grid to maintain a fixed positional relationship among the at least three arms.
